(19) United States
(12) Patent Application Publication
(10) Pub. No.: US 2011/0186657 A1
(43) Pub. Date: Aug. 4, 2011

(54) VEHICLE MOUNTED UNMANNED WATER CANNON

(75) Inventor: Sean Haviland, Croydon (AU)

(73) Assignee: HAVILAND NOMINEES PTY LTD, Knoxfield, State of Victoria (AU)

(21) Appl. No.: 12/866,479

(22) PCT Filed: Jun. 2, 2009
(86) PCT No.: PCT/AU2009/000692

§ 371 Date: Aug. 6, 2010

(51) Int. Cl. B60P 3/30; A62C 27/00; F41B 9/00

(52) U.S. Cl. 239/722

(57) ABSTRACT

An unmanned remotely controlled mobile vehicle mounted water cannon including, ground engaging drive means supporting a body, a nozzle mounted to a mounting arm extending from the forward end of the vehicle, the mounting arm being moveable relative to the body, means carried at the rear of the body for receiving fluid from a fluid supply and a pump to supply fluid through a conduit extending from the rear to the front of the vehicle; a power supply to supply power to the ground engaging drive means and a control means for receiving instructions from a remote controller.

The ground engaging means moves the vehicle across a surface and the height of the body above the ground is less than the width and length of the vehicle. The mounting arm controls the direction of the nozzle by moving sections of the mounting arm and directing fluid projected there from, the mounting arm being structured to not rise above the height of the top of the vehicle. The control means controls the drive means and the nozzle direction in response to instructions received from the remote controller.

### FIELD OF THE INVENTION

The invention relates to an unmanned all terrain vehicle mounted water cannon. The vehicle has been developed for use in applications listed below (including; but not limited to) fire fighting/fire suppression; washing/cleaning of mine site, processing, construction and quarry equipment; spraying of fluids, seeds, and chemicals; dust suppression; riot control using high pressure fluids; shotcrete application of concrete and neutralisation and dispersal of chemical and oil spills.

### BACKGROUND OF THE INVENTION

Water cannons, sometimes referred to as water monitors, are generally used for projecting fluids (i.e. water, foam, additives and powders) for applications of fire fighting/fire protection. Although the fluid projected is often water, sometimes other fluids are used. “Water cannon” as used herein, and in its usual usage in this art, also encompasses devices for projecting fluids other than water, for example devices for projecting fire suppressant foam, liquid additives, powders and concrete or detergents for oil spills.

Water cannons can include a range of nozzle types. A nozzle such as the Director® (straight stream) nozzle can be used for effectively projecting a narrow stream of water a long distance. Other nozzles, such as the adjustable fog to stream nozzle and Magnum® spray head valve can produce customised shaped fluid streams for effectively wetting down an area. Other nozzles such as the mist spray nozzles can produce a fog of fine water droplets for protecting the water cannon itself and creating a safe area for fire fighters in the immediate surrounds

Known vehicle mounted water cannons have a form similar to a mini military tank in that it has a pair of continuous or endless tracks, which are effective for providing drive over rough terrain. Supported by the continuous tracks is a body in which most of the hardware (such as motors, electronics and piping, etc.) is mounted and contained. The water nozzle fitted to the water monitor is rotatable through a range of angles like the turret of a military tank. This approach conveniently allows the nozzle to be rotated so that the nozzle may project fluid in any direction.

U.S. Pat. No. 5,860,479 describes a remote fire fighting apparatus in the form of a tracked vehicle having a top mounted nozzle.

It is desirable that unmanned vehicle mounted water cannons should be relatively small, compared with, say, manned vehicles, to facilitate access to confined areas. The remote fire fighting apparatus of U.S. Pat. No. 5,860,479 describes a version which is approximately 30 inches wide. U.S. Pat. No. 5,860,479 mentions having a low centre of gravity. A low centre of gravity helps to avoid the water cannon toppling when travelling over rough and inclined surfaces.

Unmanned vehicle mounted water cannons can topple due to a force in reaction to the projected stream of fluid. Some prior art devices incorporate outrigger assemblies to address this problem. Such outrigger assemblies entail additional expense and complication and make the vehicle difficult to manoeuvre in confined spaces and on uneven and wooded areas. Some outrigger assemblies are retractable. Such unmanned vehicle mounted water cannon must advance to a position, stop and extend and set the outrigger assembly before projecting a fluid stream. This slows down the operation of the mobile unmanned water cannon. In some circumstances, the extension and setting of the outrigger is not possible, for example in confined spaces or on very rough ground. Moreover it is desirable that the unmanned vehicle mounted water cannon should be able to project fluid whilst in motion.

It is an object of the invention to provide an improved unmanned vehicle mounted water cannon.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

Unmanned vehicle mounted water cannons are useful in many applications. The applications range from fighting fires to washing down large mining equipment. Being unmanned and mobile, the water cannon can be maneuvered into hazardous and exposed environments, for example an unmanned vehicle mounted water cannon could be positioned directly in to a refinery fire front to more effectively direct a stream of water towards a fire, or in to a fire exhausting toxic smoke and fumes. Additionally, the unmanned robotic water monitor could be driven under the body of a mining dump truck or mining loader to clean the undercarriage in preparation for scheduled workshop servicing. These operations allow for extremely effective operator control, without placing a human operator in any direct or immediate danger.

Unmanned vehicle mounted water cannons can be pendant, automatically programmed or remotely controlled (wireless), or some combination thereof.

In one aspect the invention provides an unmanned mobile vehicle mounted water cannon including,

ground engaging drive means supporting a body to move the vehicle across a surface so that the height of the body above the ground is less than the width and length of the vehicle;

a nozzle mounted to a mounting arm extending from the forward end of the vehicle,

the mounting arm being moveable relative to the body and having means to move sections of the mounting arm to control the direction of the nozzle and direct fluid projected there from, the mounting arm being structured to not rise above the height of the top of the vehicle;

means carried at the rear of the body for receiving fluid from a fluid supply and a pump to supply fluid through a conduit extending from the rear to the front of the vehicle;

a power supply to supply power to the ground engaging drive means, means to move sections of mounting arm and pump and

control means for receiving instructions from a remote controller, the control means controlling the drive means and the nozzle direction in response to the instructions received from the remote controller.

By mounting the nozzle at a low point, rather than on top as in the conventional “mini tank” construction, the unmanned vehicle mounted water cannon is better able to resist toppling due to the force in reaction to the forceful projection of fluid. Disclosed herein is a novel construction wherein the nozzle is mounted at a forward end of the body facilitating lower mounting of the nozzle than the conventional mini tank construction. Preferred embodiments of this novel construction have improved resistance to toppling due to force in reaction to the forceful projection of fluid.

The position and range of movement of the mounting arm for the nozzle is important. The inability for a machine to disseminate fluids on the move will limit its capabilities to aggressively attack a fire and gain control at a given distance. In order to fight fires from all angles whether it is static or in motion the monitor or nozzle must generally be capable of 360 degree vertical and 360 degree horizontal rotation and projects water and or a water foaming agent mixture through port induction. Thus, it is preferable that the nozzle when mounted to the water monitor, is capable of at least 180 degree rotation in both the horizontal and vertical plane.

In a preferred form of the invention, the mounting arm extends from the forward end of the vehicle at a point less than half the height of the vehicle. The body and ground engaging means are arranged so that the vertical centre of gravity of the vehicle is less than half the height of the vehicle.

The area beneath the ground engaging means defines a footprint on the surface or terrain; the footprint being defined by the points of ground engagement of the ground engaging means. The body, ground engaging means and mounting arm are arranged so that the cumulative effect of the weight distribution of the vehicle and the reaction force attributable to the fluid projected from the nozzle acts through the footprint of the ground engaging means particularly when the nozzle is projecting water or foam forward of the vehicle in a direction within the 180 degree arc in both the horizontal and vertical plane.

As this is the most common angle of application of water or foam from the vehicle, it is important that the vehicle can discharge water, foam and any required liquids/powders at maximum velocity and/or volume in this range of projection. However by having the mounting arm extending forward of the front of the body, the nozzle may be able to project water beyond 180 degree in a vertical and horizontal plane relative to the forward direction of the vehicle and preferably 270 degrees relative to the forward direction in both the vertical and horizontal plane. Preferably the control means is arranged to stop the drive means in the absence of a signal from the remote control. Preferably the unmanned vehicle mounted water cannon further includes options of a camera and/or thermal monitoring means for monitoring direct heat, and transmission means for providing feedback to a user at the remote control. These monitoring means may be mounted to any desirable body location preferably the front, and behind a protective window, to permit adequate detection and appropriate signalling to the operator from any operating angle.

Optionally thermal monitoring means for monitoring radiant heat and control means for controlling the unmanned vehicle mounted water cannon in response to the thermal monitoring means, may be included.

Preferred embodiments of the unmanned vehicle mounted water cannon include a pump and a power supply to drive the pump to pressurise the fluid. The power supply may be an internal combustion engine, such as a diesel engine. The engine may be water cooled and/or air cooled. An oxidant supply for supplying oxidant to the power supply in depleted oxygen environments may be included.

Optionally the drive means may include hydraulic motors for taking energy from the fluid to drive the body. Preferably the drive means include a continuous track on each side of the body.

The unmanned vehicle mounted water cannon may include an hydraulic pump for taking energy from the hydraulic fluid circuit of the drive means to manoeuvre the nozzle relative to the body.

Additional nozzle means may be provided for projecting fluid to protect the vehicle or used by personnel working with the vehicle. Preferably the additional nozzle means are arranged to direct fluid onto at least a portion of the drive means.

The unmanned vehicle mounted water cannon may be intrinsically safe for operation in flammable/gaseous operating environments.

The means for receiving fluid may include a connector by which the unmanned vehicle mounted water cannon may be fluidly connected to and drag a hose. Optionally a hose reel, in which case the unmanned vehicle mounted water cannon preferably includes a reel drive means for rotating the reel to retract hose may be provided either as an extension for the water inlet or as a separate water outlet. The means for receiving fluid is rearwardly mounted on the body so that the unmanned vehicle mounted water cannon may include a swivel mount so that the vehicle may advance without entanglement with hoses. The rear mounting of the hose reel also assists in balancing the fluid reaction forces resulting from the forward mounted nozzle.

The unmanned vehicle mounted water cannon may find use in at least on application selected from the group of;—
1. robotic Fire Fighting/Robotic Fire Suppression in areas such as:—refineries, chemical factories, petrochemical industry, grassland fires, wildfire fires, underground coal mines, surface coal mines, surface and underground hardrock mines using fluids, chemicals, additives, foam suppressants and powders.
2. robotic washing/cleaning of heavy vehicle (off highway) and light vehicle (On Highway) equipment such as:—dump trucks, excavators, draglines, shovels, dozers, loaders, water trucks, 4WD's, buses, side tippers, haul trucks.
3. robotic washing/cleaning of minesite, processing, construction and quarry equipment such as:—conveyors, conveyor and work platform structures, storage pond liners, boilers, hardstands, workshop floors and structures, process plants.
4. robotic hydraulic (water) high pressure mining of tailings, surface and underground mining materials/ores. Including underground open stope mining.
5. robotic spraying of fluids, seed and chemicals to aid in the rehabilitation/revegetation of mining, landfill, waste management and agricultural land.
6. robotic dust suppression using fluids, chemicals or water additives to apply to ore stockpiles, overburden waste stockpiles, haul roads, conveyors and broad acre areas of disturbed soil/dusty material
7. robotic riot control using fluids to control personnel for security purposes
8. robotic Shotcreting to apply concrete for stabilisation of underground minesite wall and roofing structures, and
9. robotic neutralisation and dispersal of chemical and oil spills using fluids and additives.

### BRIEF DESCRIPTION OF THE DRAWINGS

FIG. 1 is a plan view of an embodiment of the invention;

FIG. 2 is a side view of the embodiment of the present invention shown in FIG. 1;

FIG. 3 is a perspective view of the unmanned vehicle mounted water cannon of FIG. 2, and

FIGS. 4 to 6 are a side view of an embodiment of the invention to which a boom extension has been fitted.

### DETAILED DESCRIPTION OF THE EMBODIMENTS

“Footprint” as used herein refers to a region of ground spanned or engaged by the ground engaging drive means. By way of example, if an unmanned vehicle mounted water cannon had drive means in the form of four wheels as in a conventional car, the footprint would be a rectangular region defined by the four points at which the wheels contact the ground. In the case of a vehicle having one of a pair of continuous tracks on each side of the vehicle, the footprint is a rectangular region, two sides of which are defined by the outer edges of the continuous tracks.

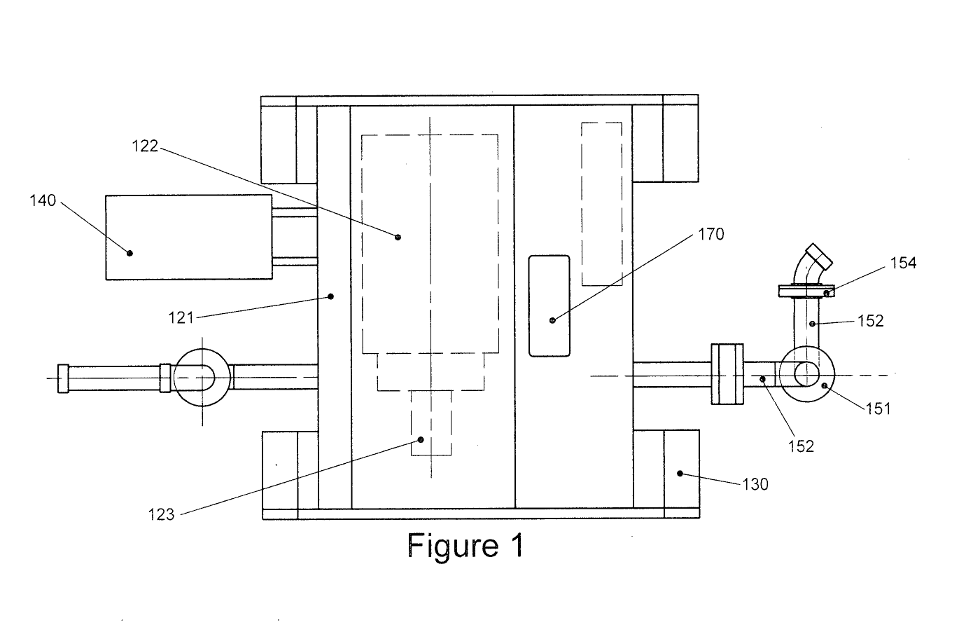

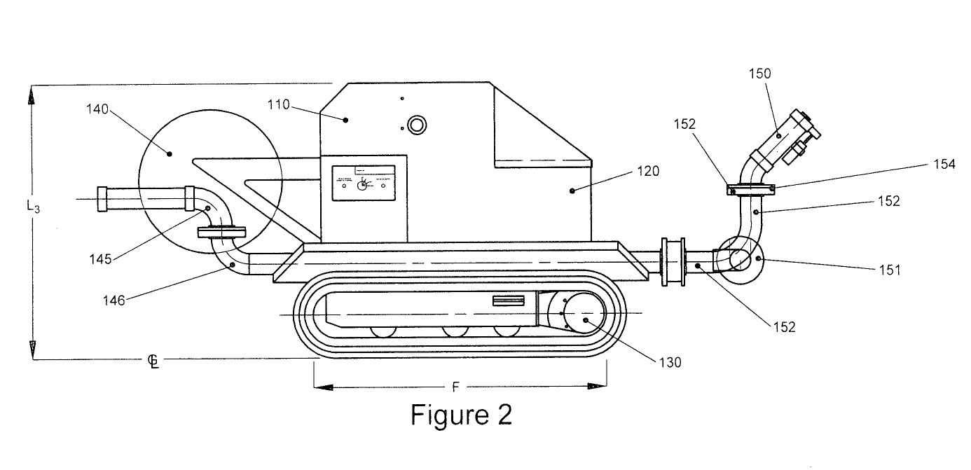

FIGS. 1, 2 and 3 illustrate an unmanned vehicle mounted water cannon in accordance with an embodiment of the invention.

The unmanned vehicle mounted water cannon 110 includes a body 120. The body 120 is supported by ground engaging drive means 130 in the form of continuous tracks. The body and ground engaging means are arranged so that the vertical centre of gravity of the vehicle is less than half the height of the vehicle. The body comprises a cowling or bonnet 121 which covers the drive means and control devices. The drive means is preferably a diesel engine 122 which drives an hydraulic pump 123 coupled thereto. Hydraulic fluid from pump 123 is used to power the ground engaging means which is typically an endless track boggy. The ground engaging drive means 130 define a footprint F.

A rearwardly mounted water inlet 145 is provided for connection to a supply hose. Rear swivel design on the supply piping permits the water supply hose to follow the travelling unit without becoming entangled in the drive tracks, restricting water flow or impeding travel movement. The coupling is designed to accept water supply from both fixed and mobile pumping supplies with water pressures rated up to 400 PSI.

The water inlet communicates with a conduit 146 which extends preferably below the centre of gravity of the vehicle to a forward mounting arm. A nozzle 150 is low mounted at a forward end of the body 120. The mounting arm of the water cannon 160 is mounted to the forward end of the body 120 by bent pipe sections 152 and rotatable bearing assemblies 151, 154 and a 30° bent section 153. Bearing assemblies 151 are in accordance with the bearing assemblies described in Australian patent no 2001279494, the contents of which is incorporated herein by reference. Bearing assembly 151 permits rotation of the bent pipe section 152 about a vertical plane and assembly 154 permits rotation about plane perpendicular to that of section 151. Hydraulically operated water cannon is fitted with quick release nozzle changeover coupling to offer direct stream spraying or fully incremental hydraulic controlled fog-jet nozzle with optional foam induction.

The nozzle 150 connected to bent arm section 153 can operate at a range of upward inclinations down to an angle α with respect to the inclination of the vehicle, in this case about 23°, whilst maintaining a projection of the reaction force within the footprint F. Through this range of angles, a large volume of fluid may be projected via the nozzle 150, thereby generating large reaction forces, without the water cannon 110 toppling.

The arrangement of the body, ground engaging means and mounting arm ensure that even at lower angles wherein a projection of the reaction force extends outside of the footprint F′, water cannons according to the present invention have significant advantages over the prior art. The cumulative effect of the weight and weight distribution of the vehicle and the reaction forces attributable to the fluid acting through the nozzle acts through the footprint of the ground engaging means. For example, the nozzle 150 might be rotated to project water horizontally resulting in a horizontal reaction force. Due to the mounting position of the mounting arm to the body being below half the vertical height of the vehicle and the low mounting of the nozzle 150, the dimension L₃, being the perpendicular dimension between the reaction force and the toppling point at the rearmost extent of the footprint F, is less than prior art devices. As a result, the toppling torque, which is the product of the reaction force and position on the vehicle through which it acts is counteracted by the weight distribution and so the vehicle is stable. This preferred embodiment of the present invention is thereby able to project a greater volume of water in the horizontal dimension than in the prior art. For simplicity, the principles of the present invention have been described with reference to an unmanned water cannon seated on horizontal ground. This is also the case where the terrain upon which the vehicle is moving is at an angle to the horizontal or uneven. In this case, the weight contribution due to the low centre of gravity is still well within the footprint and even at the most unfavourable angle of fluid projection, the reaction force attributable to the fluid projection is insufficient to topple the vehicle. This would not be the case with the prior art. Of course similar principles apply when the device is seated on inclined and/or uneven ground.

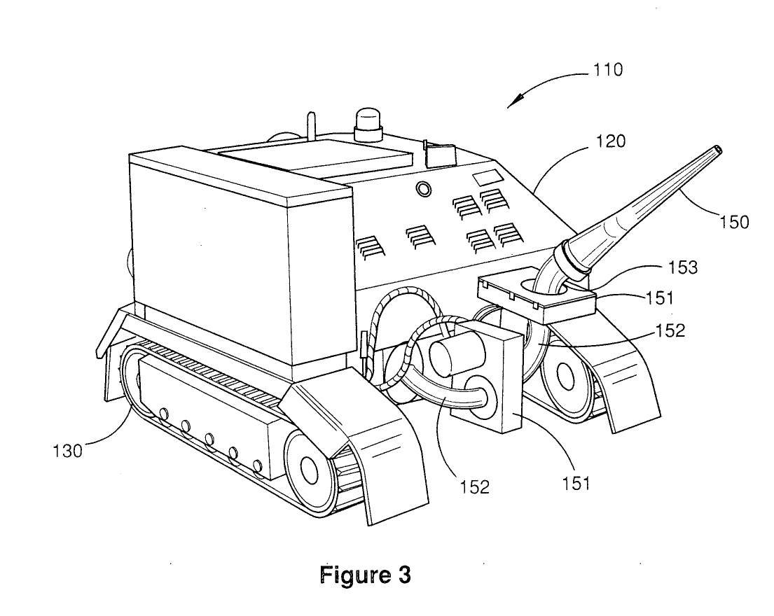

This preferred embodiment shown in FIG. 3 is remote controlled. The remote control could be either by radio control or optic fibre guidance in underground setting. In this embodiment, the remote control system is a radio frequency (RF) device including independent systems for the drive means and controlling the nozzle. Each of the drive means and nozzle control system is mounted on a separate printed circuit board and operates on separate radio frequencies. The independence of these two systems reduces the likelihood of a simultaneous loss of control over the drive means and the nozzle. In the event of the failure of only one system, the vehicle 110 is still able to protect itself from fire using a water spray or by maneuvering away from a hazard. Both the nozzle and the drive means control systems are configured to stop in the event of a loss of signal. This creates a fail-safe mode of operation whereby the nozzle is prevented from spraying uncontrollably and similarly the drive means are prevented from carrying on when not in control of an operator. Alternatively, the unit could be configured to operate with an open water stream failsafe from the water monitor to continuously deliver fluids to a dedicated area in the event of losing signal. This would be suitable if operating to cool a holding tank or fight a specified fire. Desirably, the remote control unit is lightweight, say less than 3 kg or so, and is ergonomically designed with a front mounted shoulder harness to be comfortably carried and handled by an operator.

Through a radio controlled joystick, the operator controls all operations associated with the equipment for maximised on site safety. This unit is extremely light weight (less than 3 kg), offers long battery operation (+24 hours) and is provided with a shoulder harness arranged for front mounting so the control unit is very ergonomic for easy operator use with minimised operator fatigue from control concentration or physical effort. The control unit has an in built safety mechanism that stops the unit's travel if the radio frequency control sequence is lost between joystick and receiver.

Mounted within the body 120 is a diesel engine 122 operable to drive the pump 123 for pressurising the hydraulic fluid system. Oxygen sensors are mounted on the air intake to the diesel engine and are operative to monitor the level of oxygen in the atmosphere. The drive means 130 includes rubber continuous tracks. Rubber continuous tracks are cost-effective and provide a good level of grip on most surfaces. Optional steel tracks can be substituted to serve specified custom applications as required.

The unmanned vehicle mounted water cannon 110 includes remote hydraulically controlled on/off engaged sprinkler system with spray nozzles capable of saturating rubberized tracks and the vehicle 110 itself with cooling sprays to enable the vehicle 110 to operate in close proximity to and around the fire zone. The self cooling allows the vehicle to traverse through flame and into fire zones not previously attempted due to extreme radiant heat. The sprays are also very effective in self cleaning the equipment during and after operational use.

A reel 140 is mounted at the rear of the body 120. Mounted within the reel 140 is another hydraulic motor (not shown) operative to drive and rewind the reel. The hydraulically operated remote control rewind hose reel allows for safe and easy unwinding of 3″ layflat supply water hose and collection of hose at completion of job for transporting.

The hose on the reel may be used as a separate outlet with a separate water nozzle to provide access to a person in proximity to the vehicle when the vehicle is in use. The hydraulically operated remote control rewind hose reel to allow for safe and easy unwinding of ¾″-1.5″ pressure water hose for assistant operation with combating fires and chemical hazards. This feature is particularly useful for automatic collection of hose at completion of a job or, for transporting; and protects the operator from injury caused by fatigue in dangerous and labour intensive operating conditions.

This preferred embodiment has a low centre of gravity allowing it to traverse hilly terrain, climb over obstructions in the roadway up to a certain height and with ramps negotiate obstructions in the way. It can pull fully charged hoses for distances of over 400 feet (120 m) on most terrains without loss of traction. The water cannon's balance and hydrostatic track drive has exhibited the capability to accomplish multiple fire fighting roles from carrying fully charged multiple water lines acting as a mule, pack another hard hose reel enabling another fireman to work in tandem with the water cannon 110, and carry foam containers in excess of 75 gallons (80 L) in various operational settings. It has demonstrated its ability to pull fully charged hoses in off road muddied clay bogs. It is by its low profile, size, and modest weight able to operate in confined and limited spaces. The design of the vehicle allows it to be placed in most building elevators and be moved up to higher floors via elevator or stairs. Some prior art vehicles on the market have limited use in commercial or residential buildings due to size and weight as load limits exist in these buildings.

The incorporation of a remote controlled hydraulic water monitor onto the unmanned vehicle enables both 360 degree vertical and 360 degree horizontal movement through gear and pinion. The monitor also provides remote controlled hydraulic nozzle settings from stream /to fan /to fog and the nozzle can also operate with integrated foam induction along with remote hydraulic actuated on/off knife gate valving capable of influencing fluid flow and fluid pressure to monitor nozzle set up.

The mounting arm is mounted in the sub frame area at or below the centre of gravity. This achieves a low centre of gravity below half the height of the vehicle that allows the machine to disseminate water and or fire extinguishing fluids without affecting stability or operational control of the track crawler.

Due to the strategic placement of a solid steel conduit running through the vehicle's subframe a fluid supply hose can be connected on the back end of the crawler with a remotely controllable water monitor nozzle placed on the front end. This enables the apparatus to operate in either static or kinetic motion without disrupting its stability or its functionality as it projects fluids through its nozzle. Due to its strategic placement of the conduit and water monitor the vehicle is able to manoeuvre throughout any given terrain and not be limited to a static fighting position. In other words the forward and aft and side to side balance of the machine is not influenced whether the vehicle is projecting fluids or the monitor is rotating through its 360 degree vertical and 360 horizontal movements while projecting fluids is an advancement over other prior art vehicles. The mounting arm is designed to optionally fit a wide range of designed water cannons to offer varying volumetric flows/water throw performances whilst maintaining a lowest centre of gravity (C.O.G.) for equipment stability and minimised overall height for excellent access when operating within/beneath confined clearances.

The water monitor's performance may be integrated with the video display and computer activated commands to set out procedures and direct the monitor's placement of water in relation to the fire's positioning, spread, and intensity.

The unmanned vehicle mounted water cannon 110 incorporates the video communication capabilities in relation to the machine functional parameters and will also set up the pattern for the vehicle's movements. The video monitor 170 which comprises a wireless camera mounted in various locations atop the vehicle may transmit images back to the operator via normal video camera monitor, infrared, thermal imaging, GPS transponder. The camera is protected in a shrouded weather proof enclosure in the desired locations on the machine to offer full operator visual control for forward and reverse movements.

The video monitor to water monitor and vehicle positioning computer link will be interfaced with geographical and global positioning system (GPS), thermal monitoring and imaging of its surrounding area of operation. The incorporation of GPS and monitoring of both the machine's external operating temperature and thermal imaging of the fire that it is projecting fluids upon will send messages to guide the operator in the best practices at controlling the fire at hand. The interactive program will set nozzle flow control, water monitor angle and positioning, proximity of vehicle in relation to the fire both distance and approach. The program will tell the operator the best means to control the fire at hand and tell the vehicle to protect itself from radiant heat by reading the thermal temperature in and around the machine and in response thereto activate the machine's remote hydraulically activated sprinkler system to protect the machine as it operates in the extreme radiant heat generated by operating in close proximity to the fire. The operator's ability to monitor the vehicle's condition and compensate through self protection of its rubberized tracks and its internal components will enable the track crawler to penetrate into the fire zone and accomplish tasks that were not possible with prior art devices. It is realized that this device does carry video and infrared remote visual display for the operator, but in areas of extreme smoke saturation GPS guidance along with thermal imaging will allow the operator to have forward looking capabilities. It will in essence observe the fire and operate independent of visual camera guidance in extreme conditions. The operator will know the task at hand and will know where the vehicle is in the area of operation and be able to act and react accordingly.

This preferred embodiment includes a remote controlled gear and pinion drive associated therewith and is capable of 360 degree vertical and horizontal position of the water monitor for all angles of fluid dissemination remote hydraulically controlled foam induction system attached to nozzle capable of injecting desired percentage 1-6% foam solution on call, and is capable of supporting multiple role applications. It can carry hydraulic hard hose reel outfitted with 1″×150′ hard hose line with hand held nozzle. It can also pull numerous fully charged hoses (either attached directly to the water monitor piping or acting as a mule dragging fully charged hoses for other fire fighter's in the brigade) and carry foam tanks between 50 to 100 gallon totes via external attachment in order to accomplish foam injection.

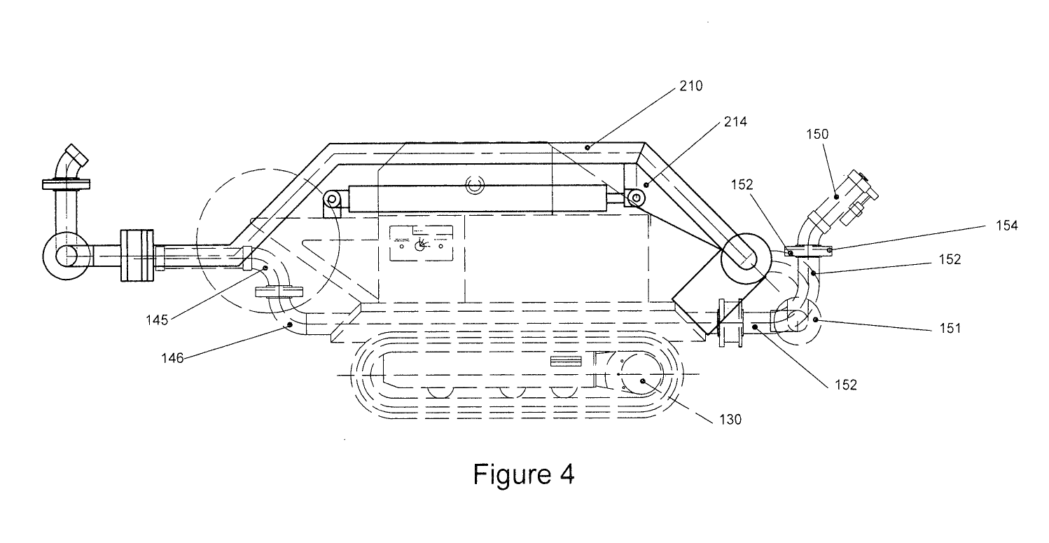

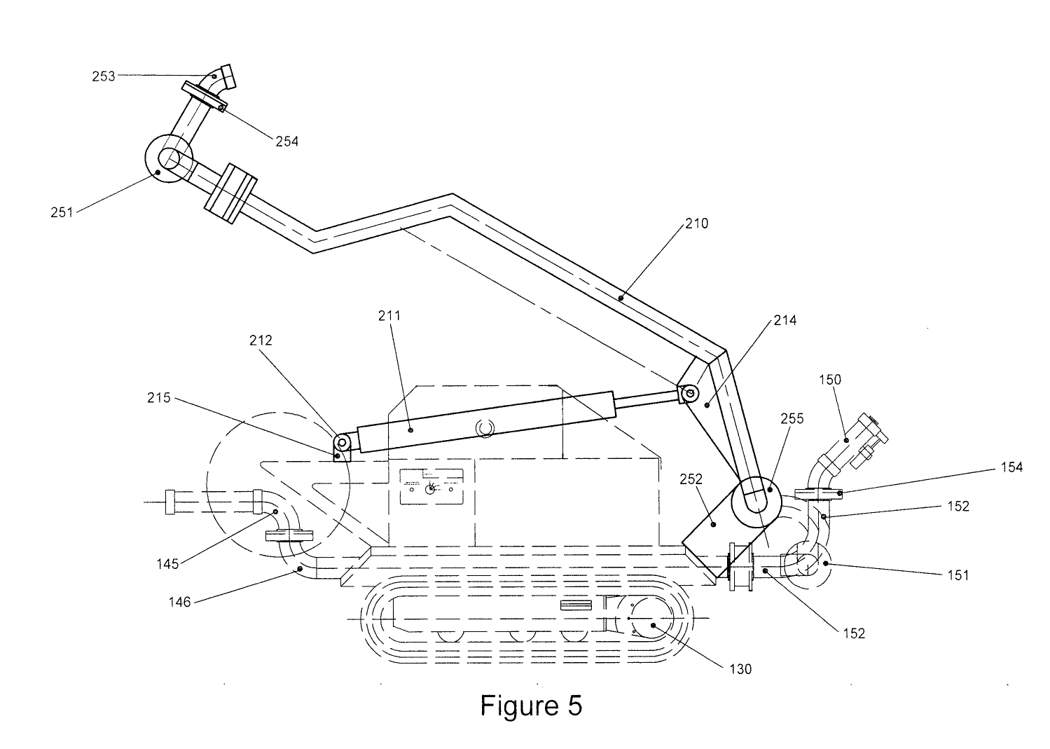

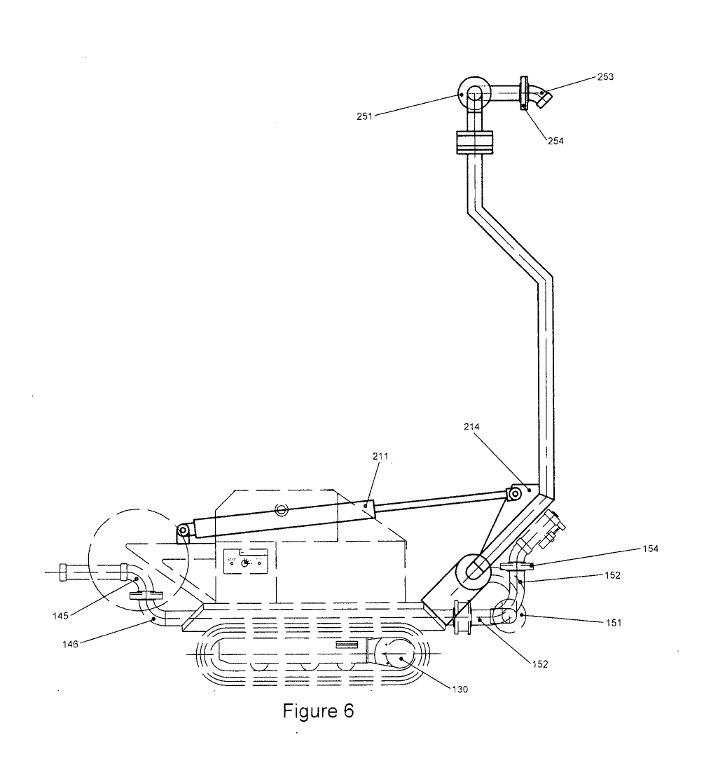

In a further preferred embodiment shown in FIGS. 4-6, the forward mounting arm includes a boom extension 210 to permit the water cannon (not shown) to be raised to an elevated position. FIGS. 4 to 7 show the boom being raised. The boom extension 210 includes a single hydraulic cylinder arm 211 and is able to maintain good stability while in the raised position. The preferred boom length is 3.2 meters.

The hydraulic cylinder arm 211 is pivotally connected at 212 to mounting 215 at the rear of the vehicle and pivotally at 213 to support flange 214 of boom arm 210. The rear mounting is to a secure point connected to the sub-frame of the vehicle. The proximal end of the boom arm 210 cooperates with bearing assembly 255 to enable the boom to be raised and lowered. The bearing is supported by a mounting 253 connected to the subframe of the vehicle. The distal arm of the boom arm 210 is provided with rotatable bearing assemblies 251, 254 (similar to bearings 151, 154) in orthogonally opposite planes which allow movement of a nozzle (not shown) connected to bent arm section 253.

The boom extension enables the water cannon to be located in elevated positions when the boom is extended. When retracted the cannon can be located in a low position away from the body to reach underneath and clean equipment.

It is contemplated that the invention could be applied to a range of applications including fire fighting, petrochemical, surface mining and underground mining. The application to hydraulic mining has particular advantages over prior art hydraulic mining techniques in that a vehicle in accordance with the invention is not limited to static operation of water monitor set up and could offer up less environmental damage as one could more effectively work in a smaller scope and decrease the mass erosion effects that are common with hydraulic mining. The ability of the vehicle mounted water cannon to gain closer proximity to the area to be mined should be an advantage.

1. An unmanned remotely controlled mobile vehicle mounted water cannon including,
ground engaging drive means supporting a body to move the vehicle across a surface so that the height of the body above the ground is less than the width and length of the vehicle;
a nozzle mounted to a mounting arm extending from the forward end of the vehicle,
the mounting arm being moveable relative to the body and having means to move the sections of the mounting arm to control the direction of the nozzle and direct fluid projected there from, the mounting arm being structured to not rise above the height of the top of the vehicle;
means carried at the rear of the body for receiving fluid from a fluid supply and a pump to supply fluid through a conduit extending from the rear to the front of the vehicle;
a power supply to supply power to the ground engaging drive means, means to move sections of mounting arm and pump and
control means for receiving instructions from a remote controller, the control means controlling the drive means and the nozzle direction in response to instructions received from the remote controller.

2. The vehicle of claim 1 wherein the mounting arm extends from the forward end of the vehicle at a point less than half the height of the vehicle.

3. The vehicle of claim 1 wherein the body and ground engaging means are arranged so that the vertical centre of gravity of the vehicle is less than half the height of the vehicle.

4. The vehicle of claim 1 wherein the region beneath the ground engaging means defines a footprint on the surface or terrain; the footprint being defined by the points of ground engagement of the ground engaging means.

5. The vehicle of claim 4 wherein the body, ground engaging means and mounting arm are arranged so that the cumulative force of the weight distribution of the vehicle and the reaction force attributable to the fluid projected from the nozzle acts through the footprint of the ground engaging means.

6. The vehicle of claim 1 wherein the control means is arranged to stop the drive means in the absence of a signal from the remote control.

7. The vehicle of claim 1 further including a camera and/or thermal monitoring means for monitoring direct heat, and transmission means for providing feedback to a user at the remote control.

8. The vehicle of claim 7 further including thermal monitoring means for monitoring radiant heat and control means for controlling the unmanned vehicle mounted water cannon in response to the thermal monitoring means.

9. The vehicle of claim 1 further including a pump and a power supply to drive the pump to pressurise the fluid to control water cannon and vehicle motion plus powering all attached auxiliary option controls to the vehicle.

10. The unmanned vehicle mounted water cannon of claim 1 further including additional nozzle means for projecting fluid to protect the water cannon.

11. The unmanned vehicle mounted water cannon of claim 10 wherein the additional nozzle means are arranged to direct fluid onto at least a portion of the drive means.

12. The unmanned vehicle mounted water cannon of claim 1 wherein the ground engaging means include a continuous track on each side of the body.

13. The unmanned vehicle mounted water cannon of claims 1 wherein the means for receiving fluid includes a connector by which the unmanned vehicle mounted water cannon is fluidly connected and able to drag a hose.

14. The unmanned vehicle mounted water cannon of claim 1 further comprising a second outlet comprising a hose reel connecting with the water supply.

15. The unmanned vehicle mounted water cannon of claim 14 further include a reel drive means for rotating the reel to retract hose.

16. The unmanned vehicle mounted water cannon of claim 1 wherein the forward mounting arm is provided with an extension boom connected by means to raise and lower the boom

17. Use of the vehicle of claim 1 for at least application selected from the group of petrochemical dispersion surface mining, underground mining, truck and mining equipment washing, hydraulic mining, stockpile dust suppression, minesite rehabilitation (aquaseeding), hard stand and processing area cleaning, boiler cleaning, and conveyor cleaning.
